(19) United States
(12) Patent Application Publication
(10) Pub. No.: US 2015/0134223 A1
(43) Pub. Date: May 14, 2015

(54) ADAPTIVE CRUISE CONTROL APPARATUS OF VEHICLE WITH SENSING DISTANCE REGULATION FUNCTION AND METHOD OF CONTROLLING THE SAME

(71) Applicant: MANDO CORPORATION, Pyeongtaek-si (KR)

(72) Inventor: Hyun Wook KIM, Suwon-Si (KR)

(21) Appl. No.: 14/308,672

(22) Filed: Jun. 18, 2014

(30) Foreign Application Priority Data
Nov. 14, 2013 (KR) 10-2013-0138656

(51) Int. Cl. B60W 30/14

(52) U.S. Cl. CPC B60W 30/14
USPC 701/93

(57) ABSTRACT

Provided are an adaptive cruise control (ACC) apparatus of a vehicle with a sensing distance regulation function, in which, when a target vehicle is selected so as to maintain a proper distance between his or her own vehicle and a target vehicle, a target vehicle candidate present within a deceleration required distance calculated using deceleration of the his or her own vehicle is selected as the target vehicle from among target vehicle candidates present between a pre-set maximum sensing distance and a minimum secure distance set according to a speed of the his or her own vehicle so that an unnecessary vehicle can be prevented from being wrongly sensed, and a method of controlling the ACC apparatus.

### BACKGROUND

1. Field of the Invention

The present invention relates to an adaptive cruise control (ACC) apparatus of a vehicle with a sensing distance regulation function and a method of controlling the same, and more particularly, to an ACC apparatus of a vehicle with a sensing distance regulation function, in which a vehicle in a region in which his or her own vehicle runs is accurately selected as a target vehicle from among several front vehicles so that a proper distance between the vehicle in the his or her own vehicle and the target vehicle can be maintained and comfortable driving can be provided, and a method of controlling the same.

2. Discussion of Related Art

An adaptive cruise control (ACC) apparatus is a system that automatically drives a vehicle at a speed set by a driver, measures a distance between vehicles in real time through a radar sensor mounted in the front of the vehicle so as to maintain a proper distance between the vehicles, and maintains a safe distance between the vehicle and the preceding vehicle even without the driver's repetitive manipulation of an acceleration pedal and a brake pedal, thereby assisting with safe driving of the vehicle.

There are a plurality of patent applications regarding ACC, such as Korean Patent Laid-open Publication No. 2011-60244 (published on Jun. 8, 2011, Title of the invention: Adaptive Cruise Control System and Method thereof) and Korean Patent Laid-open Publication No. 2012-139151 (published on Dec. 27, 2012, Title of the invention: Smart Cruise Control system and Method for Controlling Distance between Vehicles Using the System).

In the adaptive cruise control (ACC) system including the above inventions, when there is no preceding vehicle, if the preceding vehicle is found while a vehicle is driven at a constant set speed, the ACC system drives by acceleration or deceleration so as to maintain a proper distance between the vehicle and the preceding vehicle. In this case, a maximum sensing distance is about 150 m, and the sensing distance is linearly regulated according to the speed of his or her own vehicle so that sensing of a target in an unnecessary region is limited.

However, in the ACC system using only a radar, a driving path of the his or her own vehicle is calculated based on a current driving path. Thus, reliability of the ACC system is lowered in a long distance region and on a road in which a curvature varies, such that a situation in which a vehicle on the next lane is wrongly sensed or a vehicle on the lane in which the his or her own vehicle runs is sensed in a sensed-unsensed-sensed manner, occurs frequently.

### PRIOR-ART DOCUMENT

### Patent Document

[Document 1] Korean Patent Laid-open Publication No. 2011-60244 (published on Jun. 8, 2011) entitled “Adaptive Cruise Control System and Method thereof”

[Document 2] Korean Patent Laid-open Publication No. 2012-139151 (published on Dec. 27, 2012) entitled “Smart Cruise Control System and Method for Controlling Distance between Vehicles Using the System”

### SUMMARY OF THE INVENTION

The present invention is directed to an adaptive cruise control (ACC) apparatus of a vehicle with a sensing distance regulation function, in which, when a target vehicle is selected so as to maintain a proper distance between his or her own vehicle and the selected target vehicle, a target vehicle candidate present within a deceleration required distance calculated using deceleration of the his or her own vehicle is selected as the target vehicle from among target vehicle candidates present between a pre-set maximum sensing distance and a minimum secure distance set according to the speed of the his or her own vehicle so that an unnecessary vehicle can be prevented from being wrongly sensed, and a method of controlling the same.

According to an aspect of the present invention, there is provided an adaptive cruise control (ACC) apparatus that controls a motion of his or her own vehicle so that a proper distance between the his or her own vehicle and a front vehicle present in front of the his or her own vehicle can be maintained, the ACC apparatus including an electronic control unit that determines target vehicle candidates present between a pre-set maximum sensing distance and a minimum secure distance set according to a speed of the his or her own vehicle using information of the front vehicle received from a sensing section that measures information of the front vehicle present in front of the his or her own vehicle and that selects a target vehicle candidate present within a deceleration required distance calculated using the deceleration of the his or her own vehicle as a target vehicle from among the determined target vehicle candidates.

The electronic control unit may include: a receiving section that receives the information of the front vehicle measured by the sensing section; a target vehicle selection section that determines target vehicle candidates present within the pre-set maximum sensing distance using distances between the his or her own vehicle and the front vehicles included in the received information of the front vehicle and selects a target vehicle candidate present at a shorter distance than the minimum secure distance as a target vehicle from among the determined target vehicle candidates; and a vehicle motion controller that performs deceleration control on the his or her own vehicle so that the proper distance between the his or her own vehicle and the selected target vehicle can be maintained.

If a target vehicle candidate is present at a farther distance than the minimum secure distance, the target vehicle selection section may calculate a deceleration required distance using deceleration of the his or her own vehicle and a relative speed of the target vehicle candidate.

The maximum sensing distance may be set to be proportional to a speed of the his or her own vehicle.

The minimum secure distance may be set to be proportional to a speed of the his or her own vehicle.

According to another aspect of the present invention, there is provided a method of controlling an adaptive cruise control (ACC) apparatus, the method including: receiving information of a front vehicle that is installed at his or her own vehicle and is present in front of the his or her own vehicle; determining target vehicle candidates present within a pre-set maximum sensing distance based on the received information of the front vehicle; if a target vehicle candidate is present outside a minimum secure distance that is set according to a speed of the his or her own vehicle from among the determined target vehicle candidates, calculating a deceleration required distance using deceleration of the his or her own vehicle; and selecting a target vehicle candidate present within the calculated deceleration required distance as a target vehicle.

The method may further include, after the determining of the target vehicle candidates, selecting a target vehicle candidate present at a shorter distance than the minimum secure distance as a target vehicle from among the determined target vehicle candidates.

The calculating of the deceleration required distance may include calculating a deceleration required distance using the deceleration of the his or her own vehicle and a relative speed of the target vehicle candidate.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 a view for describing an adaptive cruise control (ACC) apparatus of a vehicle with a sensing distance regulation function according to an embodiment of the present invention;

FIG. 2 is a view for describing an electronic control unit illustrated in FIG. 1;

FIG. 3 is an operational flow chart illustrating a method of controlling an ACC apparatus of a vehicle with a sensing distance regulation function, according to an embodiment of the present invention;

FIG. 4 is a graph showing a maximum sensing distance and a minimum secure distance that are set according to a speed of his or her own vehicle; and

FIG. 5 is a graph showing a deceleration required distance according to a relative speed.

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

Hereinafter, an exemplary embodiment of the present invention will be described in detail with reference to the accompanying drawings.

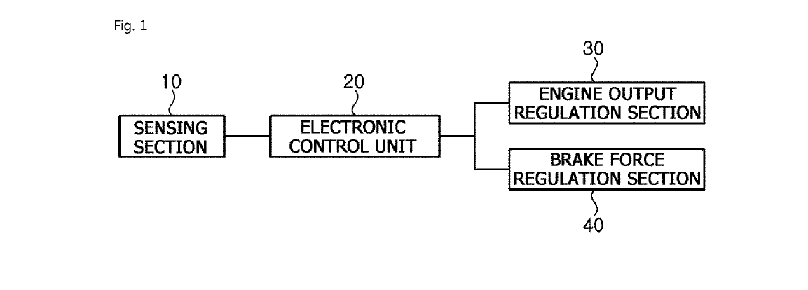

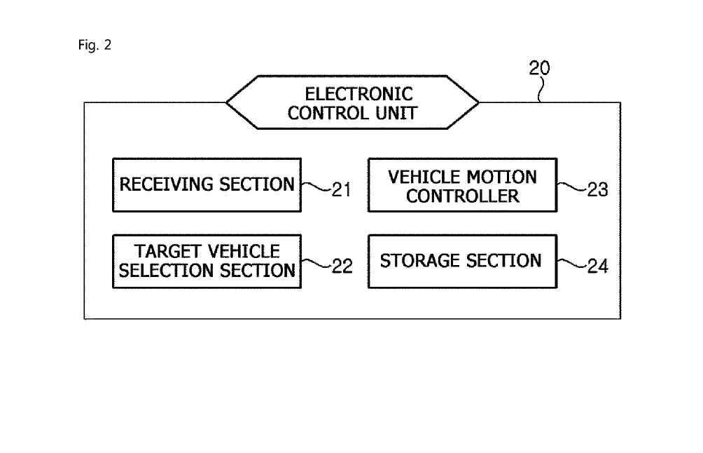

FIG. 1 is a view for describing an adaptive cruise control (ACC) apparatus of a vehicle with a sensing distance regulation function according to an embodiment of the present invention, and FIG. 2 is a view for describing an electronic control unit illustrated in FIG. 1.

Referring to FIG. 1, the ACC apparatus of the vehicle with the sensing distance regulation function according to the current embodiment of the present invention includes an electronic control unit 20 that performs acceleration/deceleration control on his or her own vehicle so as to maintain a pre-set proper distance between the his or her own vehicle and a target vehicle selected as a target from among information of a front vehicle measured by a sensing portion 10 that is installed at the his or her own vehicle and is measure information of the front vehicle present in front of the his or her own vehicle.

The sensing portion 10 is a radar sensor, and senses the front vehicle present in front of the his or her own vehicle. The sensing portion 10 measures a distance between the his or her own vehicle and the front vehicle and a relative speed of the his or her own vehicle with respect to the front vehicle using an result of the sensing. The sensing portion 10 may further include a wheel sensor, a steering angle sensor, and a yaw rate sensor as well as the radar sensor.

The electronic control unit 20 is connected to a driver interface (not shown) that inputs driver's instructions for setting whether the ACC apparatus operates and for setting a distance between the vehicles when ACC is performed. The driver interface includes an input apparatus, such as a button disposed on an operating panel of the vehicle.

The electronic control unit 20 selects a front vehicle present at a shorter distance than a pre-set minimum secure distance as a target vehicle using information of the front vehicle measured by the sensing portion 10, in greater detail, a distance between the vehicles according to the front vehicle from among the information of the front vehicle and controls the motion of the his or her own vehicle so that a proper distance between the his or her own vehicle and the selected target vehicle can be maintained.

In particular, the electronic control unit 20 determines the front vehicle present within a pre-set maximum sensing distance as target vehicle candidates from among the information of the front vehicle present in front of the his or her own vehicle, selects a target vehicle candidate present at a shorter distance than a minimum secure distance set according to a speed of the his or her own vehicle as a target vehicle from among the determined target vehicle candidates, and calculates a deceleration required distance and selects a target vehicle candidate present within the calculated deceleration required distance as a target vehicle if the target vehicle candidate is outside the minimum secure distance. If the target vehicle candidate is present within the maximum sensing distance and the minimum secure distance, the target vehicle is far away from the his or her own vehicle in spite of being a vehicle at a short distance or is driving at a speed similar to that of the his or her own vehicle.

Also, when an acceleration required torque is generated so that a proper distance between the his or her own vehicle and the target vehicle can be maintained, the electronic control unit 20 provides the generated acceleration required torque to an engine output regulation portion 30. The engine output regulation portion 30 drives a throttle valve that determines a quantity of fuel supply according to an engine torque generated in correspondence to the acceleration required torque and regulates an engine output.

Also, if deceleration control is required, the electronic control unit 20 provides a deceleration required torque to a brake force regulation section 40. The brake force regulation section 40 regulates a brake force applied to wheels according to a brake torque generated according to the deceleration required torque.

When further describing with reference to FIG. 2, the electronic control unit 20 includes a receiving section 21, a target vehicle selection section 22, a vehicle motion controller 23, and a storage section 24.

The receiving section 21 receives information of the front vehicle present in front of the ego vehicle measured by the sensing section 10. The information of the front vehicle includes a distance between the front vehicle and the his or her own vehicle and the relative speed of the his or her own vehicle.

The target vehicle selection section 22 extracts a maximum sensing distance that is set to be proportional to the speed of the his or her own vehicle using the distance between the vehicles from among the information of the front vehicle received by the receiving section 21 and determines the front vehicle present within the extracted maximum sensing distance as target vehicle candidates. In this case, even though the information of the front vehicle present within the maximum sensing distance are the target vehicle candidates, the information of the front vehicle that deviates from the maximum sensing distance is excluded from the target vehicle candidate. The maximum sensing distance is stored in the storage section 24 to be proportional to the speed of the his or her own vehicle.

The target vehicle selection section 22 selects the target vehicle candidate present at a shorter distance than a pre-set minimum secure distance, i.e., a minimum secure distance that is set according to the speed of the his or her own vehicle as a target vehicle from among the determined target vehicle candidates.

If the target vehicle candidate exists outside the above-described minimum secure distance, the target vehicle selection section 22 calculates a deceleration required distance using the deceleration of the his or her own vehicle and the relative speed of the target vehicle candidate and selects a target vehicle candidate present within the calculated deceleration required distance as a target vehicle. If there is no target vehicle candidate within the deceleration required distance, the target vehicle selection section 22 determines that no target vehicle is present in front of the his or her own vehicle.

The vehicle motion controller 23 controls the motion of the vehicle so that a proper distance between the his or her own vehicle and the target vehicle selected by the target vehicle selection section 22 can be maintained. The minimum secure distance according to deceleration is stored in the storage section 24 so as to be set to be proportional to the deceleration of the his or her own vehicle.

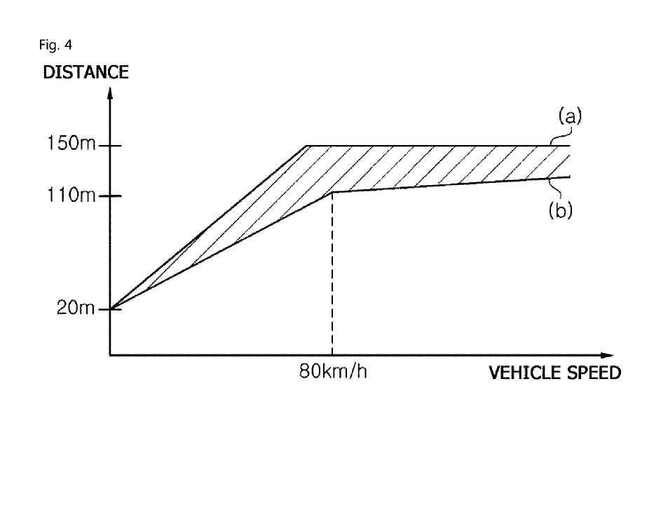

As shown in the graph of FIG. 4, (a) is a graph showing a maximum sensing distance according to the speed of the his or her own vehicle, and (b) is a graph showing a minimum secure distance according to the speed of the his or her own vehicle, and a hatched region between (a) and (b) represents a deceleration required distance, i.e., a regulation region. When braking is performed in the regulation region, the minimum secure distance according to the speed of the his or her own vehicle can be set by experiences so that smooth braking can be performed.

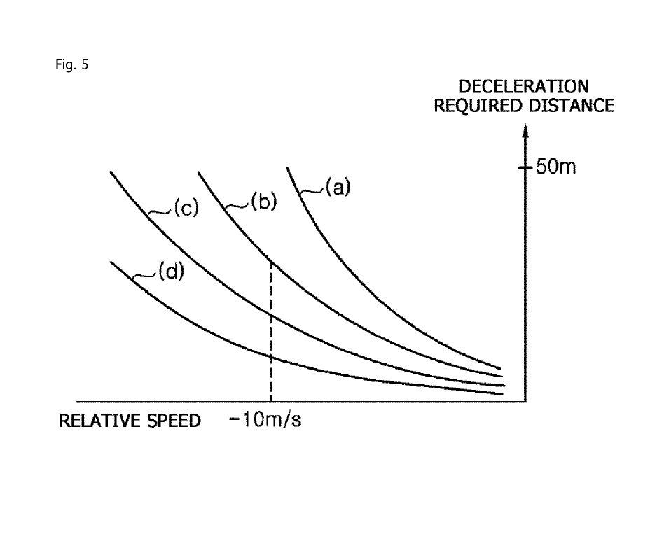

In FIG. 5, (a) represents a deceleration required distance according to the relative speed of the his or her own vehicle with respect to the target vehicle when deceleration of the his or her own vehicle is 0.5 m/s², and (b) represents a deceleration required distance according to the relative speed of the his or her own vehicle with respect to the target vehicle when deceleration of the his or her own vehicle is 1 m/s², and (c) represents a deceleration required distance according to the relative speed of the his or her own vehicle with respect to the target vehicle when deceleration of the his or her own vehicle is 1.5 m/s², and (d) represents a deceleration required distance according to the relative speed of the his or her own vehicle with respect to the target vehicle when deceleration of the his or her own vehicle is 2 m/s².

A deceleration required distance r_{decel} may be calculated by the following Equation 1.

$${r}_{decel} = - \frac{{v}_{rel}^{2}}{2 {a}_{rel , host}} , \qquad [ Equation 1 ]$$

, where a_{rel,host} is target deceleration of the his or her own vehicle, and vᵣₑₗ is a relative speed of the target vehicle. The relative speed of the target vehicle is a value that is received from the sensing section 10, and the target deceleration of the his or her own vehicle is a set value. There may be a plurality of target vehicle candidates.

The vehicle motion controller 23 controls the motion of the vehicle by providing related control signals to the engine output regulation section 30 or the brake force regulation section 40 so that a proper distance between the his or her own vehicle and the selected target vehicle can be maintained.

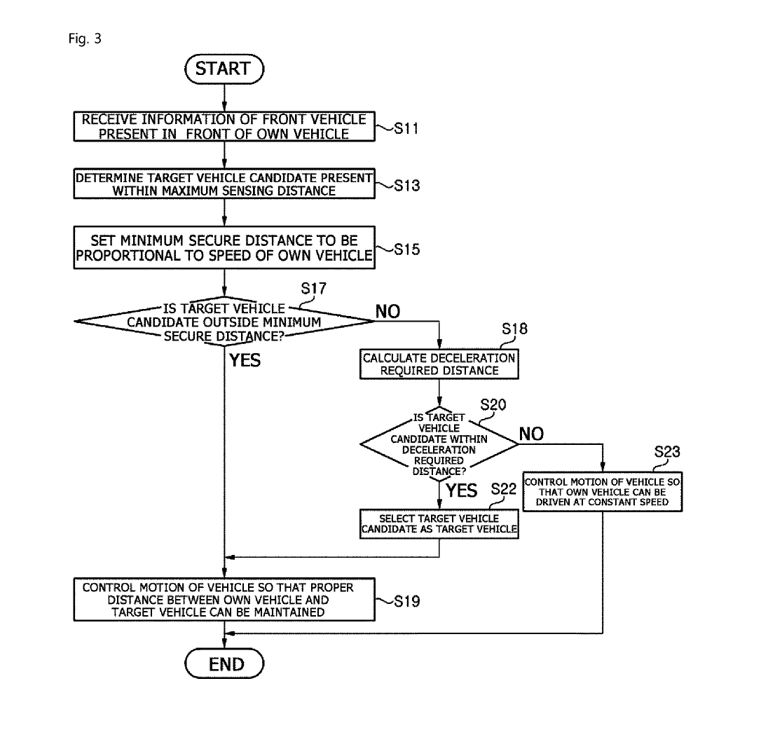

A method of controlling the ACC apparatus of the vehicle with the sensing distance regulation function having the above configuration will now be described with reference to FIG. 3.

FIG. 3 is an operational flow chart illustrating the method of controlling an ACC apparatus of a vehicle with a sensing distance regulation function, according to an embodiment of the present invention.

Referring to FIG. 3, the electronic control unit 20 receives information of a front vehicle present in front of the his or her own vehicle from the sensing section 10 (S11). A distance between the his or her own vehicle and the front vehicle is included in the information of the front vehicle.

The electronic control unit 20 determines a target vehicle candidate present within a maximum sensing distance that is set to be proportional to the speed of the his or her own vehicle from among the received information of the front vehicle (S13). That is, the electronic control unit 20 determines front vehicles, of which a distance between the front vehicle and the his or her own vehicle is within the maximum sensing distance, as target vehicle candidates.

The electronic control unit 20 sets a minimum secure distance to be proportional to the deceleration of the his or her own vehicle so as to select a target vehicle from among the determined target vehicle candidates (S15).

The electronic control unit 20 determines whether a target vehicle candidate is present within the minimum secure distance set in Operation S15 from among the determined target vehicle candidates (S17).

If, as a result of determination in Operation S17, a target vehicle candidate is present outside the minimum secure distance, i.e., if a target vehicle candidate is present at a shorter distance than the minimum secure distance with the his or her own vehicle, the electronic control unit 20 selects the target vehicle candidate as a target vehicle and controls the motion of the vehicle so that a proper distance between the his or her own vehicle and the selected target vehicle can be maintained (S19).

If, as a result of determination in Operation S17, no target vehicle candidate is present outside the minimum secure distance, the electronic control unit 20 calculates a deceleration required distance using the deceleration of the his or her own vehicle and the relative speed of the target vehicle candidate so as to select a target vehicle candidate that is present between the maximum sensing distance and the minimum secure distance as a target vehicle (S18). The deceleration required distance may be calculated using the above-described Equation 1.

The electronic control unit 20 determines whether a target vehicle candidate is present within the calculated deceleration required distance (S20).

If, as a result of determination in Operation S20, the target vehicle candidate is present within the calculated deceleration required distance, the electronic control unit 20 selects the target vehicle candidate as a target vehicle (S22), and the method returns to Operation S19 described above.

If, as a result of determination in Operation S20, no target vehicle candidate is present within the calculated deceleration required distance, the electronic control unit 20 regards that no front vehicle is present in front of the his or her own vehicle and controls the motion of the vehicle so that the vehicle can be driven at a constant speed (S23).

In this way, the target vehicle candidate present between the minimum secure distance and the maximum sensing distance that are set according to the speed of the his or her own vehicle can be accurately selected as the target vehicle so that an unnecessary vehicle can be prevented from being wrongly sensed, and the front vehicle on the lane in which the his or her own vehicle runs is the target vehicle so that comfortable driving can be provided to a driver without feeling a sense of difference of control.

As described above, according to the embodiments of the present invention, when a target vehicle is selected so as to maintain a proper distance between his or her own vehicle and the selected target vehicle, a target vehicle candidate present within a deceleration required distance calculated using target deceleration of the his or her own vehicle and the relative speed of the target vehicle candidate is selected as the target vehicle from among target vehicle candidates present between a pre-set maximum sensing distance and a minimum secure distance set according to the speed of the his or her own vehicle so that an unnecessary vehicle can be prevented from being wrongly sensed

In addition, according to the embodiments of the present invention, as the maximum sensing distance is set to be proportional to the speed of the his or her own vehicle, the front vehicle that is present farther than the maximum sensing distance can be excluded from the target vehicle candidates.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. An adaptive cruise control (ACC) apparatus that controls a motion of his or her own vehicle such that a proper distance between the his or her own vehicle and a front vehicle present in front of the his or her own vehicle is capable of being maintained, the ACC apparatus comprising an electronic control unit that determines target vehicle candidates present between a pre-set maximum sensing distance and a minimum secure distance set according to a speed of the his or her own vehicle using information of the front vehicle received from a sensing section that measures information of the front vehicle present in front of the his or her own vehicle and that selects a target vehicle candidate present within a deceleration required distance calculated using the deceleration of the his or her own vehicle as a target vehicle from among the determined target vehicle candidates.

2. The ACC apparatus of claim 1, wherein the electronic control unit comprises:
a receiving section that receives the information of the front vehicle measured by the sensing section;
a target vehicle selection section that determines target vehicle candidates present within the pre-set maximum sensing distance using distances between the his or her own vehicle and the front vehicles included in the received information of the front vehicle and selects a target vehicle candidate present at a shorter distance than the minimum secure distance as a target vehicle from among the determined target vehicle candidates; and
a vehicle motion controller that performs deceleration control on the his or her own vehicle so that the proper distance between the his or her own vehicle and the selected target vehicle is capable of being maintained.

3. The ACC apparatus of claim 2, wherein, if a target vehicle candidate is present at a farther distance than the minimum secure distance, the target vehicle selection section calculates a deceleration required distance using deceleration of the his or her own vehicle and a relative speed of the target vehicle candidate.

4. The ACC apparatus of claim 1, wherein the maximum sensing distance is set to be proportional to a speed of the his or her own vehicle.

5. The ACC apparatus of claim 1, wherein the minimum secure distance is set to be proportional to a speed of the his or her own vehicle.

6. A method of controlling an adaptive cruise control (ACC) apparatus, the method comprising:
receiving information of a front vehicle that is installed at his or her own vehicle and is present in front of the his or her own vehicle;
determining target vehicle candidates present within a pre-set maximum sensing distance based on the received information of the front vehicle;
if a target vehicle candidate is present outside a minimum secure distance that is set according to a speed of the his or her vehicle from among the determined target vehicle candidates, calculating a deceleration required distance using deceleration of the his or her vehicle; and
selecting a target vehicle candidate present within the calculated deceleration required distance as a target vehicle.

7. The method of claim 6, further comprising, after the determining of the target vehicle candidates, selecting a target vehicle candidate present at a shorter distance than the minimum secure distance as a target vehicle from among the determined target vehicle candidates.

8. The method of claim 6, wherein the calculating of the deceleration required distance comprises calculating a deceleration required distance using the deceleration of the his or her own vehicle and a relative speed of the target vehicle candidate.
